(19) United States
(12) Patent Application Publication
(10) Pub. No.: US 2002/0090119 A1
(43) Pub. Date: Jul. 11, 2002

(54) Displaying multiple slice images

(76) Inventors: Motoaki Saito, Tokyo (JP); Kazuo Takahashi, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/757,229

(22) Filed: Jan. 8, 2001

(51) Int. Cl. G06K 9/00

(52) U.S. Cl. 382/128

(57) ABSTRACT

A time series of multiple cross-sectional images of a subject are displayed in unique display formats synchronized with the acquisition of the images to provide a precise location for an invasive medical instrument, thus enabling accurate monitoring of the state and motion of the instrument during a procedure. The images are acquired through real time data acquisition apparatus, such as a real time X-ray CT scanner with a multi-line X-ray detector. Each image is displayed in a display area that is deformed to provide depth perception. Multiple display areas are displayed simultaneously on a single image display unit and the display areas can be adjusted to provide easy and continuous comparison of the spatial relationships among the images. Display areas can be overlapped and optionally assigned opacities so that overlapped images can be seen. Display areas can also be assigned opacities and displayed on a three-dimensional image reconstructed with previously acquired data.

### FIELD OF THE INVENTION

This invention relates generally to medical imaging, and more particularly to displaying multiple slice images.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 1999, TeraRecon, Inc., All Rights Reserved.

### BACKGROUND OF THE INVENTION

An X-ray computerized axial tomography (CT)apparatus can be used to visualize the position of a biopsy needle during a biopsy procedure on a subject. A continuously scanning X-ray CT apparatus has been used to observe the motion of a biopsy needle 20 during a biopsy in real time. It is reported that it is difficult to accurately understand the position of the biopsy needle when guided by X-ray CT having a time series images of a single cross section of the subject.

It is desirable to display the time series images of two or more cross-sections simultaneously for biopsy needle localization. Similarly, in interventional radiology, it is necessary to operate scalpels, needles, or catheters dynamically. In order to respond to the operation of scalpels, needles, and catheters, it is desirable to display time series images of two or more cross-sections simultaneously.

X-ray CT scanners that acquire data of two or more cross-sections using a multiline X-ray detector are able to display the image of two or more cross-sections simultaneously by reconstructing the projection data of two or more cross-sections acquired by the multi-line X-ray detector. The reconstructed images are conventionally displayed as shown in FIGS. 4 and 5 (prior art). The display formats illustrated in FIGS. 4 and 5 are explained with reference to FIG. 2, which illustrated the spatial relationship between a subject, a region of interest, a biopsy needle inserted in a subject, and CT slices from a four-line X-ray detector.

FIG. 4 illustrates a display format in which images acquired with the four-line Xray detector are displayed in a two-by-two format on the display area of a single display screen 33. The reconstructed image of slice-1 102 in FIG. 2 is displayed on image display area 111. A “1” appears as slice number 119 in the upper left comer of the image display area 111. The reconstructed image of slice-2 103 in FIG. 2 is displayed on image display area 112 in the upper right comer of the display area as slice number 2. The reconstructed image of slice-3 104 in FIG. 2 is displayed on image display area 113 in the lower left comer of the display area as slice number 3. The reconstructed image of slice-4 105 in FIG. 2 is displayed on image display area 114 in the lower right comer of the display area as slice number 4. Because the images from the four-line X-ray detectors are displayed in two rows and two columns on one display screen, it is difficult to grasp the spatial relationship and continuity of the body axis direction of the subject.

FIG. 5 illustrates a display format in which images acquired with four-line X-ray detector are displayed in a two by one format on the display area of two display screens 34 and 35. The reconstructed image of cross section-1 102 in FIG. 2 is displayed on image area 111 in a display screen 34. On the left side of the display area, the slice number is displayed as 1. The reconstructed image of cross section-2 103 is displayed on image display area 112 in a display screen 34. On the right side of the display area, the slice is displayed as 2. The reconstructed image of cross section-3 104 is displayed on image display area 113 in a display screen 35. On the left side of the display area, the slice is displayed as 3. The reconstructed image of cross section-4 105 is displayed on image display area 114 in a display screen 35. On the right side of the display area, the slice is displayed as 4. Because the images of each cross section from the four-line X-ray detector are displayed on two columns and one row on two display screens, it is difficult to grasp spatial relation and continuity of the body axis direction of a subject.

Therefore, it is desirable to provide an image display apparatus that facilitates an accurate understanding of the position of a medical instrument from the displayed images of two or more cross sections of a subject during an invasive procedure.

### SUMMARY OF THE INVENTION

A time series of multiple cross-sectional images of a subject are displayed in unique display formats synchronized with the acquisition of the images to provide a precise location for an invasive medical instrument, thus enabling accurate monitoring of the state and motion of the instrument during a procedure. The images are acquired through real time data acquisition apparatus, such as a real time X-ray CT scanner with a multi-line X-ray detector. Each image is displayed in a display area that is deformed to provide depth perception. Multiple display areas are displayed simultaneously on a single image display unit and the display areas can be adjusted to provide easy and continuous comparison of the spatial relationships among the images. In another aspect of the invention, the display areas are overlapped to provide additional depth perception. In yet aspect of the invention, each display area is assigned an opacity so that one or more display areas can been seen behind an adjacent display area when overlapped. In still a further aspect of the invention, the each display area is assigned an opacity and displayed on a three-dimensional image reconstructed with previously acquired data.

Thus, the invention enables easy comparison among a time series of adjacent cross-sections of a subject, and of spatial information of regions of interest in the images, improving the safety and simplicity of invasive procedures on a subject, such as biopsy techniques and interventional radiology that are performed under X-ray CT control.

In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a schematic block diagram showing a configuration of an image display apparatus of an X-ray CT scanner according to one embodiment of the invention.

FIG. 2 is a figure illustrating a spatial relationship between a subject, a region of interest, a biopsy needle, and CT slices.

FIG. 3 is a figure showing a spatial relationship and temporal relationship between a subject, a region of interest, a biopsy needle, and CT slices.

FIG. 4 is a figure showing a prior art method to display four images of CT slices on one display screen.

FIG. 5 is a figure showing a prior art method to display four images of CT slices on two display screens.

FIG. 6 is a figure showing a prior art method to display four images of CT slices on one display screen.

FIG. 7-20 are exemplary display formats of four images of CT slices shown on one display screen by the embodiment of the invention illustrated in FIG. 1.

FIG. 21 is a block diagram of a data-processing unit suitable for use with the invention.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

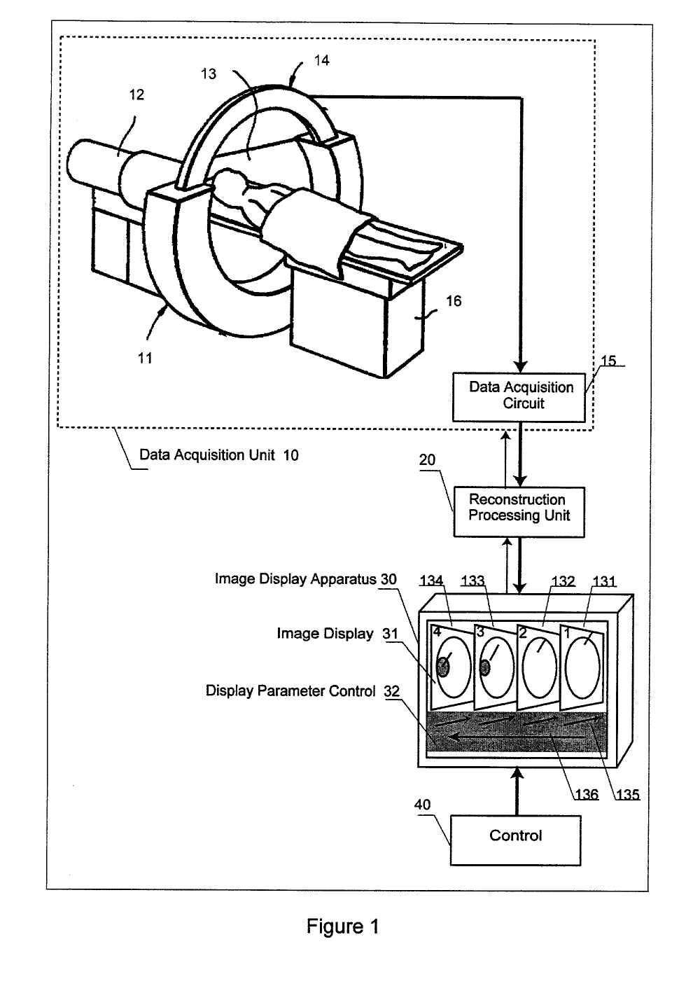

FIG. 1 is a block diagram showing one embodiment of the present invention. A data acquisition apparatus 10 collects projection data of a subject by electromagnetic radiation from the circumference and measures the transmitted dose. The data acquisition apparatus 10 is described herein as an X-ray computerized axial tomography (CT) scanner, such as an electron beam scanning type X-ray CT scanner, for purposes of explanation but the invention functions similarly in other apparatus that produce temporal images in two or more planes, such as a magnetic resonance (MR) or ultrasound apparatus, and is not limited to use with X-ray CT scanners.

The apparatus 10 controls an electron beam 13 emitted from an electron gun 12 for scanning on an X-ray target 11 annularly located around a subject. The X-ray beam by the X-ray target 11 transmits the cross section of a subject on a table 16, and a multi-line X-ray detector 14 intercepts the transmitted X-ray beam. An X-ray CT scanner that uses a rotating gantry equipped a rotating-anode X-ray tube and a multi-line X-ray detector is also contemplated as within the scope of the invention. A four-line Xray detector is used for explanation of the multi-line X-ray detector 14 but the invention can be practiced other X-ray detectors, such as an area X-ray detector, and the invention is not limited by the examples herein.

A data acquisition circuit 15 converts the output current of the multi-line X-ray detector 14 into digital data. By using the multi-line X-ray detector 14, the apparatus collects data of multiple cross-sections of the subject simultaneously. A reconstruction-processing unit 20 performs pre-processing, reconstruction processing, and postprocessing of the acquired data, and creates images of multiple cross sections of the subject simultaneously within a time synchronized with data acquisition.

An image display apparatus 30 has an image display section 31 that has display area 131, display area 132, display area 133 and display area 134 that display the temporal images of four cross-sections simultaneously acquired with the multi-line X-ray detector 14. The image display apparatus 30 has a display parameter control panel 32 to control the displayed images in the display areas. The control panel 32 has x-direction display control boxes 135 for controlling the displayed images in a first direction and a z-direction display control box 136 for controlling the displayed images in a second direction orthogonal to the first direction. It will be apparent that there are as many x-direction control boxes l35 as there are displayed images. In one embodiment, the control boxes 135, 136 are implemented as knobs or dial. In this embodiment, the control boxes 135 appears as four knobs or dials, one for each displayed image.

The control panel 32 allows the observer to deform the display format of each display area 131-134 to provide depth perception, and to change the display format for easy comparison of adjacent slices. Conventional texture mapping techniques can be employed to create the deformed slices. Frame coordinates are calculated and the resulting frame is drawn to enclose the slices (deformed or non-deformed) to create each display area 131-134.

The control panel 32 also allows the observer to overlap adjacent display areas and to give a different opacity to each display area. Each display area with a different opacity can then be arranged on a three-dimensional image reconstructed with previously acquired data. In one embodiment, the opacity for a displayed image is input as a numerical value, e.g., 0-100%. In another embodiment, a slider bar for each displayed image is used to input the opacity. Similarly, in one embodiment, a slider bar is also used to control magnification of each displayed image, which results in the overlapping of adjacent display areas.

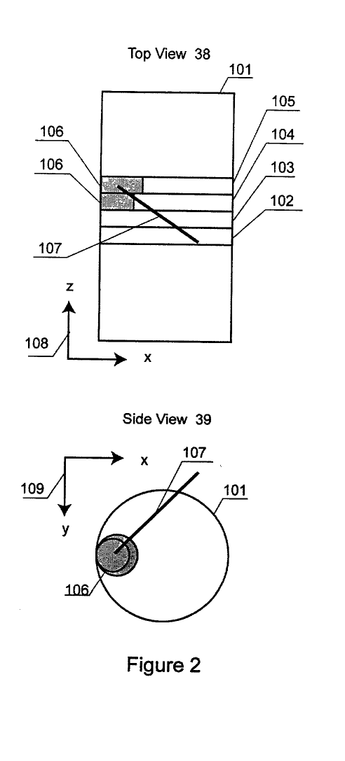

FIG. 2 illustrates spatial relationship between a subject 101, a region of interest 106, a biopsy needle inserted in a subject 107, and CT slices 102-105 from a four-line X-ray detector. The subject 101 is a patient lying on the table 16 in FIG. 1. The X-ray beam generated by the X-ray target transmits the cross section of the subject 101, and the four-line X-ray detector 14 intercepts the transmitted X-ray beam. The data acquisition circuit 15 converts output current of the four-line X-ray detector into digital data.

A top view 38 of the subject 101 as projected on an x-z plane and a side view 39 of the subject 101 as projected on an x-y plane are shown in FIG. 2. The x axis is the direction from upper left corner to upper right corner in a plane parallel to a cross-section, the y axis is the direction from the upper left comer to the lower left corner, and the z axis is the direction from the foot to the head of patient that intersects perpendicularly with the x-y plane.

In the top view 38 of FIG. 2, slice-1 102, slice-2 103, slice-3 104 and slice-4 105 are slices reconstructed using data detected with each detector line of the four-line X-ray detector 14. It shows a region of interest 106 in the slice 104 and slice 105, a biopsy needle 107 in the slice 102, 103, 104 and 105, and x-z coordinates 108. The side view 39 of FIG. 2 shows the region of interest 106, the biopsy needle 107, and x-y coordinates 109.

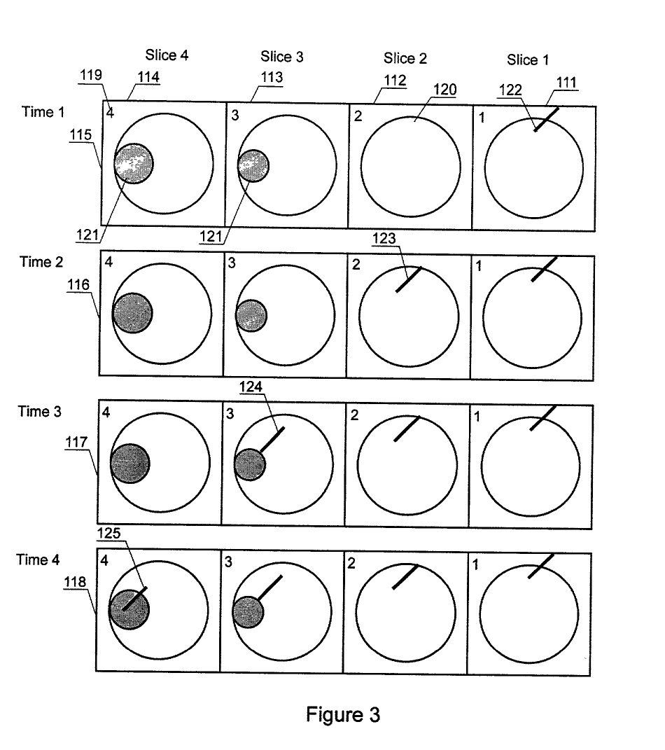

FIG. 3 shows reconstructed images of slice-1 in column 111, reconstructed images of slice-2 in column 112, reconstructed images of slice-3 in column 113, and reconstructed images of slice-4 in column 114, each image reconstructed using the projection data in the slice-1 102, slice-2 103, slice-3 104, slice-4 105 in FIG. 2 detected with each detector line of four-line X-ray detector. It shows the reconstructed images at time-1 in row 115, reconstructed images at time-2 in row 116, reconstructed images at time-3 in row 117, and reconstructed images at time-4 in row 118, each image reconstructed using the projection data at time-1, time-2, time-3, and time-4 detected with each detector line of four-line X-ray detector.

On the upper left comer of the display area of each cross-section image, a slice number 119 is displayed. The cross section 120 shown in each cross-section image is the cross section of the subject 101. The region of interest 121 shown in cross section 113 and cross section 114 is the cross section of the region of interest 106.

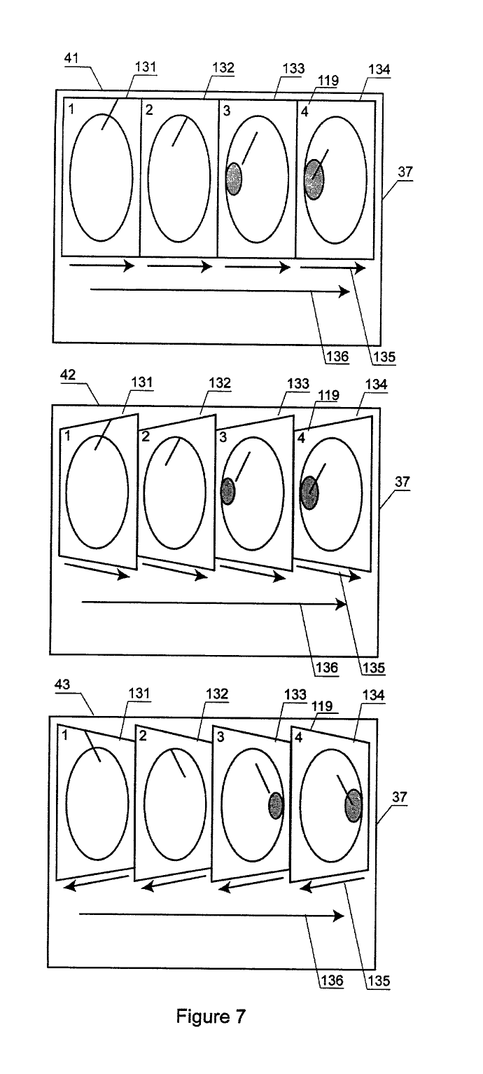

The biopsy needle 122 in the slice-1 111 at time-1 115, at time-2 116, at time-3 117, and time-4 118 shows the biopsy needle 107 contained in the slice-1 102. The biopsy needle 123 in the slice-2 112 at time-2 116, at time-3 117, and time-4 118, shows the biopsy needle 107 contained in the slice 103. The biopsy needle 124 in the slice-3 113 at time-3 117, and time-4 118 shows the biopsy needle 107 contained in the slice 104. The biopsy needle 125 in the slice-4 114 at time-4 118 shows biopsy needle 107 contained in the slice 104. FIGS. 7-20 illustrate various embodiments of the invention in displaying the slices at time-4 118.

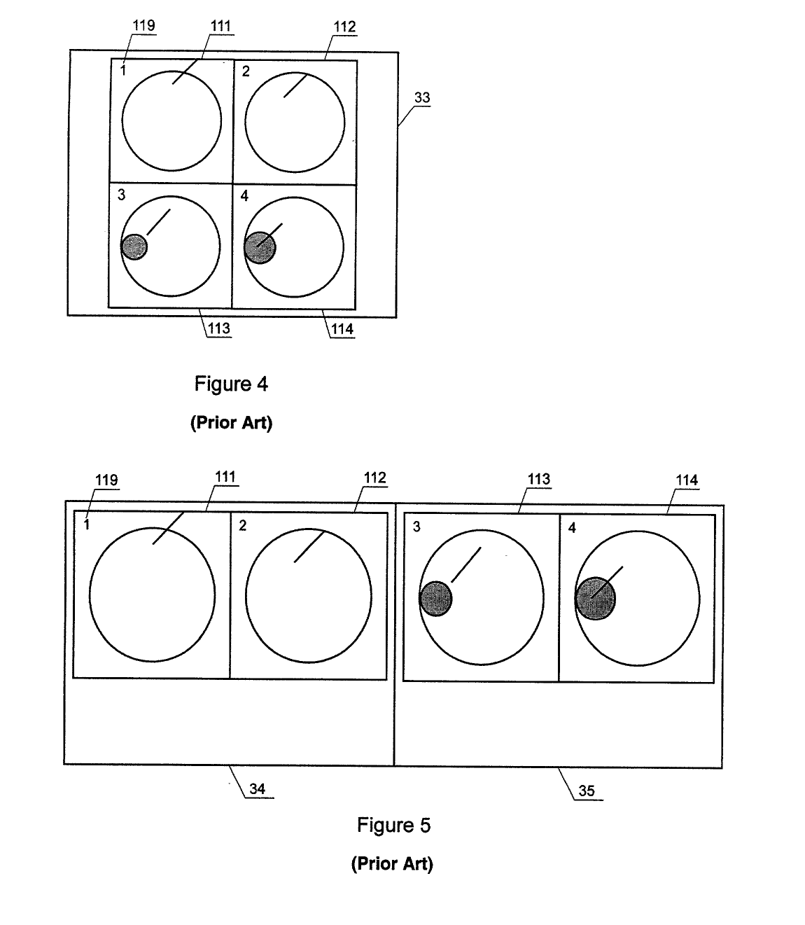

As described previously, FIG. 4 and FIG. 5 show conventional prior art display formats. In the prior display format of FIG. 4, the images of the cross sections from a four-line X-ray detector are displayed in two rows and two columns on one display screen, making it difficult to grasp the spatial relationship and continuity of the body axis direction of the subject. In the prior art display format of FIG. 5, the images of the cross section from the four-line X-ray detector are displayed in two columns and one row on two display screens, also making it difficult to grasp the spatial relation and continuity of the body axis direction of a subject.

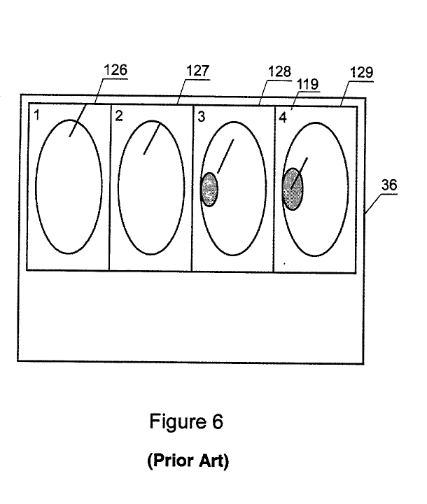

FIG. 6 illustrates a prior art display format designed to alleviate the problems of the display formats of FIG. 4 and FIG. 5. In the display format of FIG. 6, the width (x-direction) of each display area is shortened, while the height (y-direction) of each display area is maintained. The reconstructed image of cross section-1 102 is displayed on the image display area 126 of a display screen 36. On the left corner of the display area, a slice number 119 is displayed as 1. The reconstructed image of cross section-2 103 is displayed on image display area 127 in the display screen 36. The reconstructed image of cross section-3 104 is displayed on image display area 128 in the display screen 36. The reconstructed image of cross section-4 105 is displayed on image display area 129 in the display screen 36. The reconstructed images of four cross sections can now be horizontally displayed side by side on one display screen, making the comparison of the four cross sections easier than in the display formats of FIG. 4 or FIG. 5. Additionally, the distance between regions of interest in two adjacent display areas is shorter than the corresponding in FIG. 5, so viewing the cross sections during the invasive operation is easier. However, because the display format in FIG. 6 provides no information regarding the relationship and order among the images, this prior art display format does not enable easy understanding of the spatial relation and continuity of the body axis direction of a subject.

FIGS. 7-20 are examples of display formats created by the image display apparatus 30 of the present invention. The image display apparatus 30 displays multiple images side-by-side on a single display screen, and provides information and control over the x and y directions of the images. As in the prior art display format of FIG. 6, the width (x-direction) of each display area is shortened, while the height (y-direction) of each display area is maintained so that the display aspect ratio of image is changed. Unlike the display formats of FIGS. 4, 5 and 6, there is an individual x-direction display control for each display area and a global z-direction display control for all the display areas. The current directions for the x and y axes are indicated by arrows as is further described in conjunction with each of the FIGS. 7-20. Thus, as compared with the display formats of FIGS. 4, 5 and 6, the arrows enable the observer to easily understand the x-direction of the images and understand the order and relation in the z-direction of multiple images. Furthermore, changing the directions of the x and y axes cause the display areas to change accordingly to provide greater depth perception and change the displayed relationship among the images.

FIG. 7 illustrates three exemplary display formats 41, 42 and 43. In each case, the reconstructed image of cross section-1 102 is displayed on the image display area 131 of the display screen 37. In the left corner of the display areal31, the slice number 119 is displayed as 1. The reconstructed image of cross section-2 103 is displayed on the image display area 132, screen 37. In the left comer of the display area 132, the slice number 119 is displayed as 2. The reconstructed image of cross section-3 104 is displayed on the image display area 133 of the display screen 37. In the left comer of the display area 133, the slice number 119 is displayed as 3. The reconstructed image of cross section-4 105 is displayed on the image display area 134 of the display screen 37. In the left corner of the display area 134, the slice number 119 is displayed as 4.

Additionally, each image display area 131-134 has an x-direction display control box 135 that indicates the x-direction of the image and controls characteristics of the display such as inclination of the x-direction. For all four image display areas 131-134, there is one z-direction display control box 136 that indicates the order of images in the z-direction and controls order of images in the z-direction and arranges images in the z-direction.

In display format 41, each x-direction display control box 135 is set to the right, and the z-direction display control box 136 is set to the right. In display format 42, each x-direction display control box 135 is tilted to the lower right direction to deform the image display area and to give depth perception. It is sufficient to only to deform the shape of the frame of the image display area in display format 42, and it is not necessary to deform image itself. In display format 43, each x-direction display control box 135 is set to the lower left direction to deform the image display area and to give depth perception.

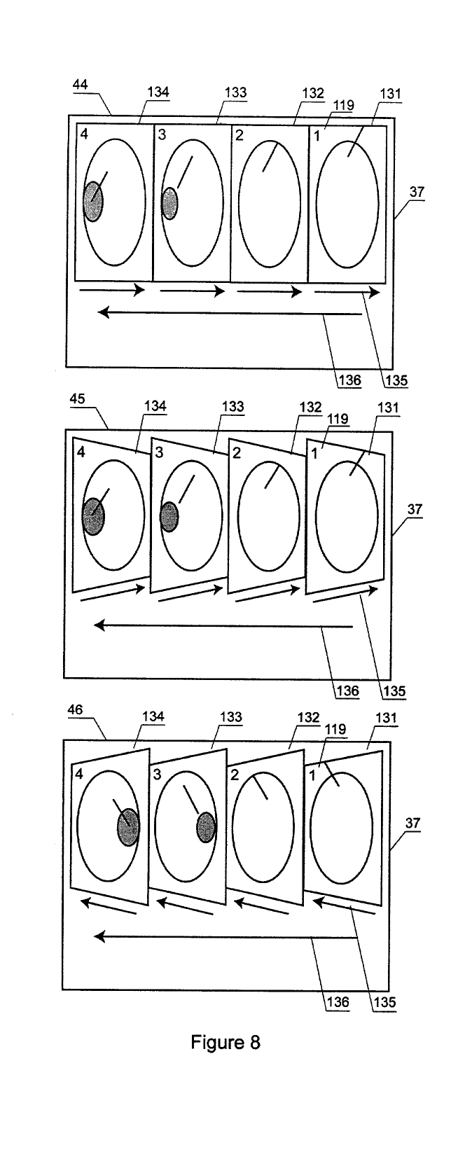

FIG. 8 illustrates three exemplary display formats 44, 45 and 46. In display format 44, each x-direction display control box 135 is set to the right, and z-direction display control box 136 is set to the left. The order of display area in the z-direction of multiple images can be changed by operation of z-direction display control box 136. In display format 45, each x-direction display control box 135 is set to the upper right direction to deform image display area and to give depth perception. It is sufficient only to deform the shape of frame of the image display area in display format 45, and it is not necessary to deform image itself. In display format 46, each x-direction display control box 135 is set to the upper left direction to deform image display area and to give depth perception.

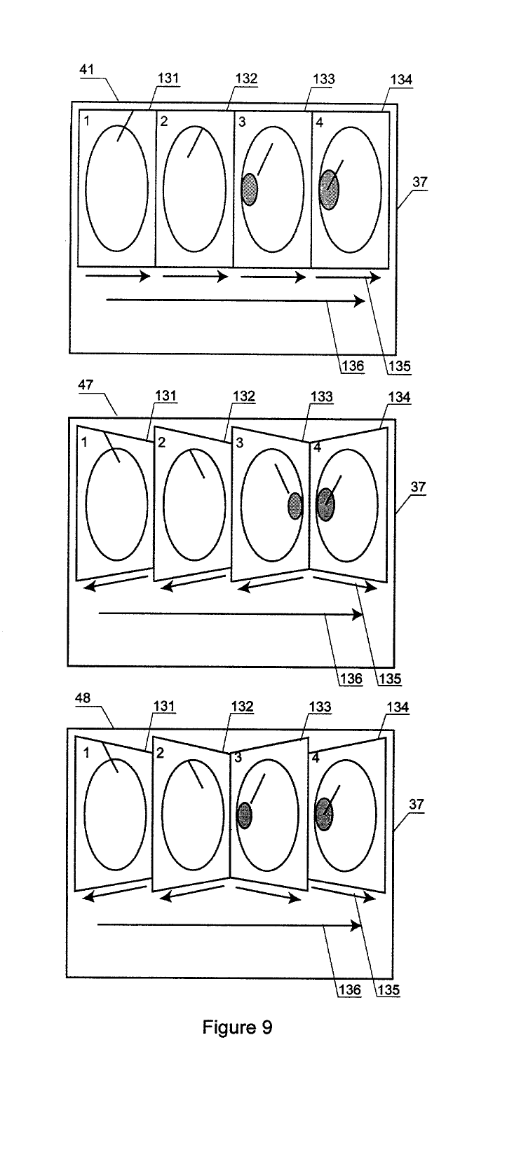

FIG. 9 illustrates two additional exemplary display formats 47 and 48. Display format 41 in FIG. 9 is same as display format 41 in FIG. 7 in which each x-direction display control box 135 is set to the right, and the z-direction display control box 136 is set to the right. In display format 47, the x-direction display control boxes 135 are set to the lower left direction in the display area 131, 132 and 133, and x-direction display control box 135 is set to lower right direction in the display area 134 to deform image display area and to give depth perception. Distance between the region of interest displayed on the image display area 133 and the image display area 134 becomes shorter than in FIG. 7. It is sufficient to only deform the shape of frame of the image display area in display format 47, and it is not necessary to deform image itself. Thus, the observer can observe the cross-sections as if he actually cut the subject between slice-3 and slice-4 and folded the slices open as if they as if they were pages in a book. In display format 48, the x-direction display control boxes 135 in the display area 131 and 132 are set to the lower left direction, and the x-direction display control boxes 135 in the display area 133 and 134 are set to lower right direction to deform image display areas and to give depth perception. Thus, the observer can observe the cross-sections as if he actually cut in the subject between slice-2 and slice-3 and folded the slices open as if they as if they were pages in a book.

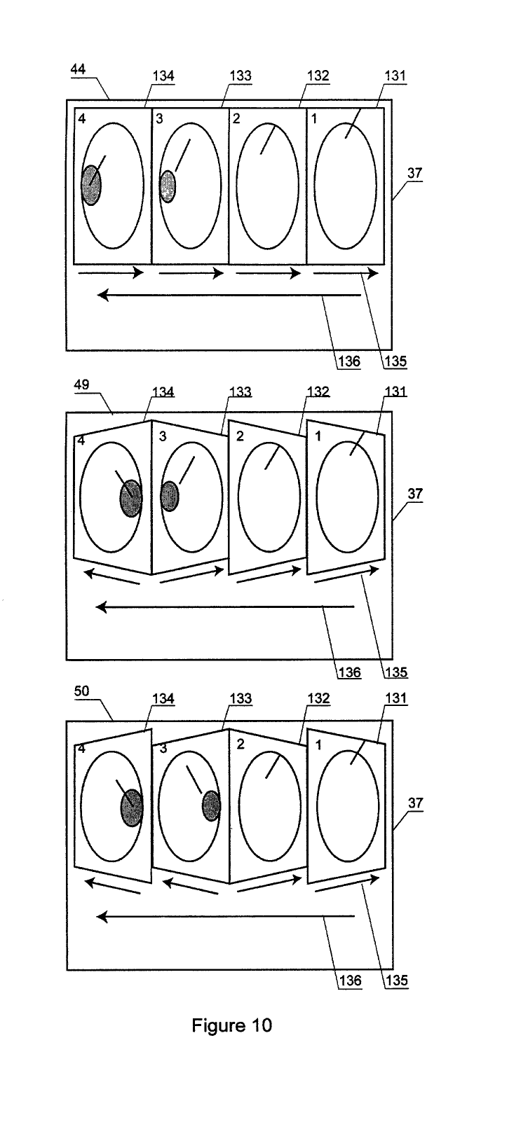

FIG. 10 illustrates two additional exemplary display formats 49 and 50. Display format 44 in FIG. 10 is same as display format 44 in FIG. 8 in which each x-direction display control box 135 is set to the right, and the z-direction display control box 136 is set to the left. In display format 49, the x-direction display control boxes 135 in the display area 131, 132 and 133 is set to the upper right direction, and the x-direction display control box 135 in the display area 134 is set to upper left direction to deform the image display area and give depth perception. The distance between the region of interest displayed on the image display area 133 and the image display area 134 becomes shorter than in FIG. 8. It is sufficient to only deform the shape of frame of the image display area in display format 49, and it is not necessary to deform the image itself. Thus, the observer can observe the cross-sections as if he actually cut the subject between slice-3 and slice-4 and folded the slices open as if they as if they were pages in a book. In display format 50, the x-direction display control box 135 in the display area 131 and 132 is set to the upper right direction, and the x-direction display control box 135 in the display area 133 and 134 are set to upper left direction to deform image display areas and give depth perception. Thus, the observer can observe the cross-sections as if he actually cut the subject between slice-2 and slice-3 and folded the slices open as if they as if they were pages in a book.

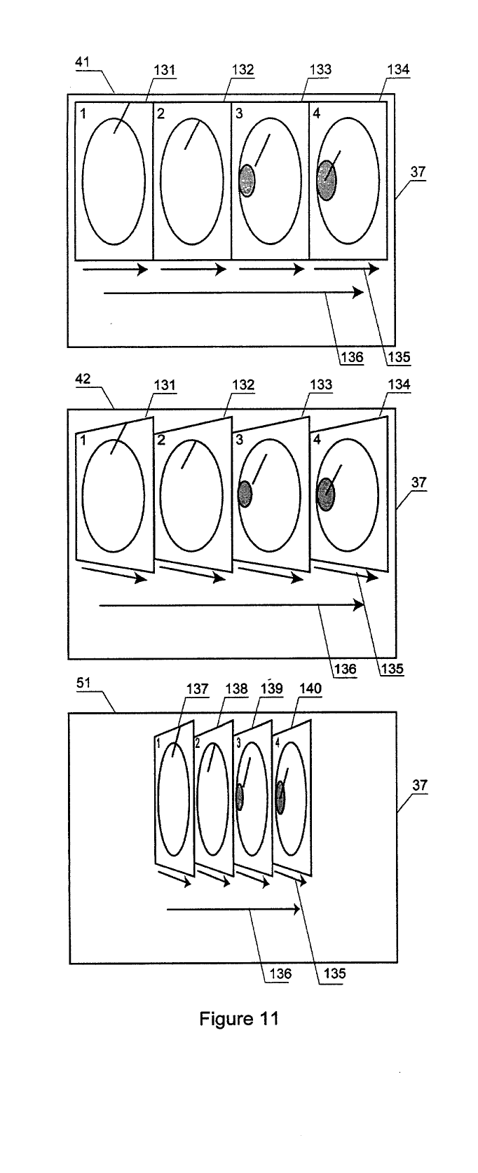

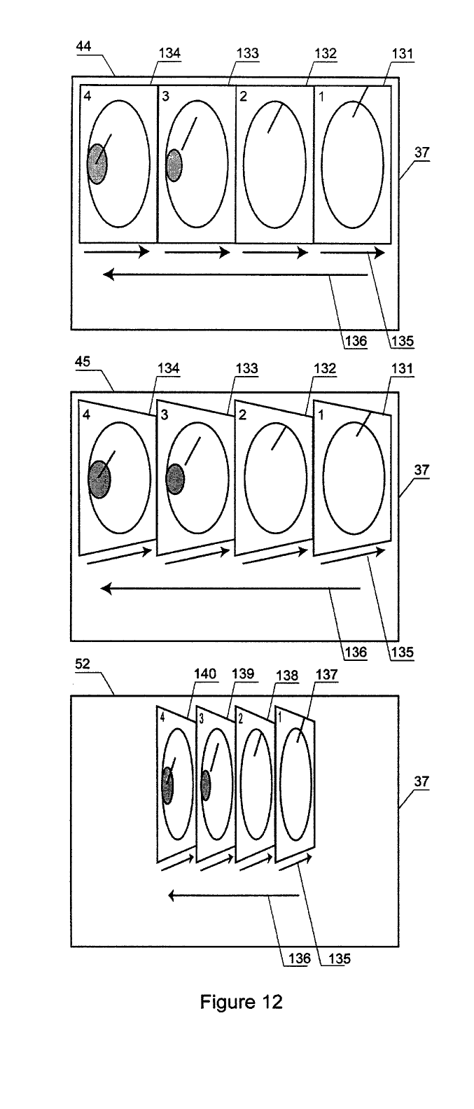

FIG. 11 and FIG. 12 illustrate display formats in which width of the display area is made narrower than in FIG. 7 and FIG. 8. By changing the width of the display area and the inclination in the depth direction, more natural depth perception may be obtained.

Display format 41 in FIG. 11 corresponds to display format 41 in FIG. 7 in which each x-direction display control box 135 is set to the right, and the z-direction display control box 136 is set to the right. Display format 42 in FIG. 11 corresponds to display format 42 in FIG. 7 in which each x-direction display control box 135 is set to the lower right direction to deform the image display area and to give depth perception, and the z-direction display control box 136 is set to the right. In display format 51 in FIG. 11, each x-direction display control box 135 is set to the lower right direction to deform the image display area to give depth perception, and the z-direction display control box 136 is set to the right. The length of the z-direction display control box 136 is set shorter than in display format 42 to shorten the width of each image display area 137, 138, 139 and 140 as compared to display areas 131, 132, 133 and 134 in display format 42. It is sufficient to only deform the shape of the frames of the image display area and to change aspect ratio of the image in display format 51, and it is not necessary to deform images themselves. Thus, the observer may get a higher depth perception than display format 42, and the observer may observe region of interest or the needle in the adjacent display areas more precisely than display format 42.

Display format 44 in FIG. 12 corresponds to display format 44 in FIG. 8 in which each x-direction display control box 135 is set to the right, and the z-direction display control box 136 is set to the left. Display format 45 in FIG. 12 corresponds to display format 45 in FIG. 8 in which each x-direction display control box 135 is set to the upper right direction to deform the image display area and to give depth perception, and the z-direction display control box 136 is set to the left. In display format 52 in FIG. 12, each x-direction display control box 135 is set to the upper right direction to deform the image display area to give depth perception, and the z-direction display control box 136 is set to the left. The length of the z-direction display control box 136 is set shorter than in display format 45 to shorten the width of each image display area 137, 138, 139 and 140 compared to display areas 131, 132, 133 and 134 of display format 45. It is sufficient to only deform the shape of frame of the image display area and to change the aspect ratio of the image in display format 52, and it is not necessary to deform the image itself. Thus, the observer may get higher depth perception than the example of display format 45, and the observer may observe the region of interest or the needle in an adjacent display area more precisely than the example of display format 45.

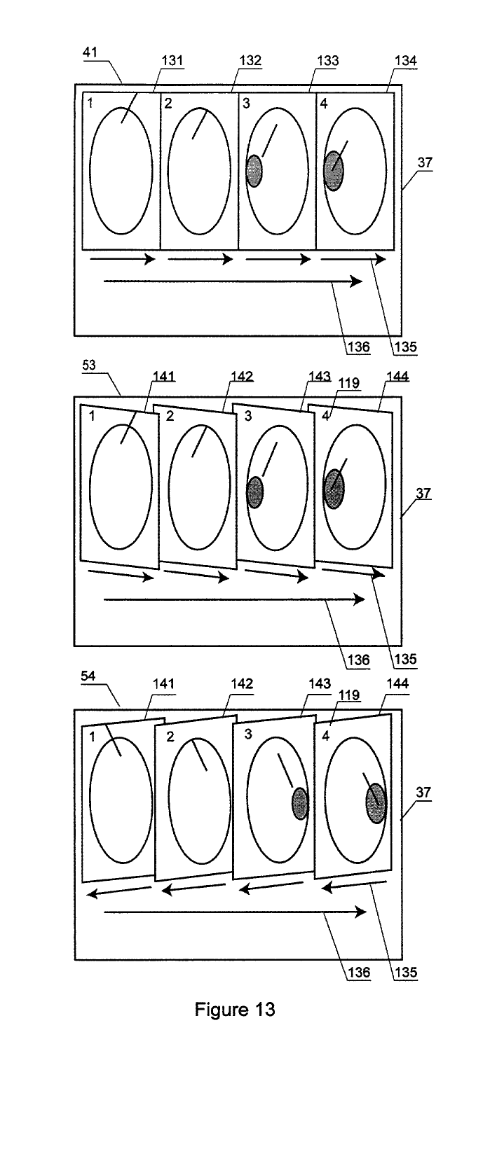

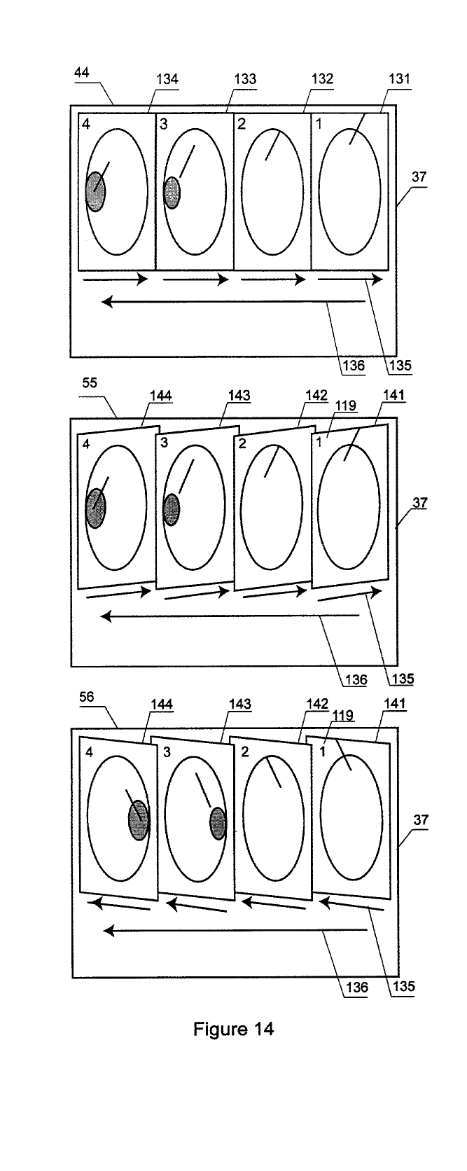

FIG.13 and FIG. 14 illustrate display formats in which image display areas are deformed into parallelograms. Display format 41 in FIG. 13 is identical to display format 41 in FIG. 7 in which each x-direction display control box 135 is set to the right, and the z-direction display control box 136 is set to the right. Display format 53 in FIG. 13 is similar to display format 42 in FIG. 7 in which each x-direction display control box 135 is set to the lower right direction to deform image display area to give depth perception, and the z-direction display control box 136 is set to the right but the shape of the display area is different than in display format 42. In display area 53, the image display area 141 for slice-1, image display area 142 for slice-2, image display area 143 for slice-3, and image display area 144 for slice-4 are deformed into parallelograms. It is sufficient only to deform the shape of the frame of the image display area in display area 53, and it is not necessary to deform image itself. Display format 54 in FIG. 13 is similar to display format 43 in FIG. 7 in which each x-direction display control box 135 is set to the lower left to deform the image display area to give depth perception, and the z-direction display control box 136 is set to the right but the shape of the display area is different than in display format 43.

Display format 44 in FIG. 14 is identical display format 44 in FIG. 8 in which each x-direction display control box 135 is set to the right, and the z-direction display control box 136 is set to the left. Display format 55 in FIG. 14 is similar to display format 45 in FIG. 8 in which each x-direction display control box 135 is set to the upper right direction to deform image display area and to give depth perception, and the z-direction display control box 136 is set to the left but the shape of the display area is different than in display format 45. In display format 55, image display area 141 for slice-1, image display area 142 for slice-2, image display area 143 for slice-3, and image display area 144 for slice-4 are deformed into parallelograms. It is sufficient to only deform the shape of the frame of the image display area in display format 55, and it is not necessary to deform image itself. Display format 56 in FIG. 14 is similar to display format 46 in FIG. 8 in which each x-direction display control box 135 is set to the upper left direction to deform image display area to give depth perception, and the z-direction display control box 136 is set to the left but the shape of the display area is different than in display format 46 by having the frame deformed into a parallelogram.

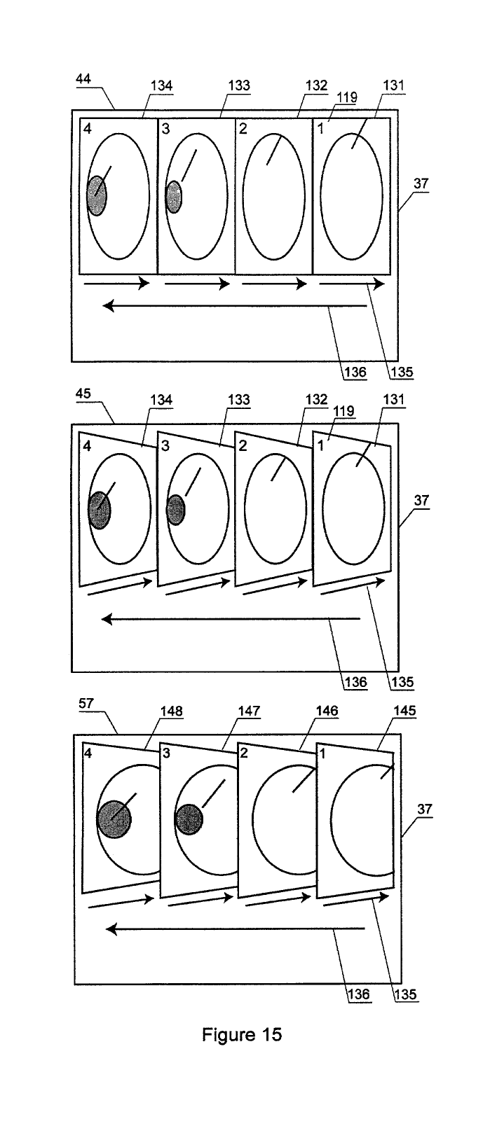

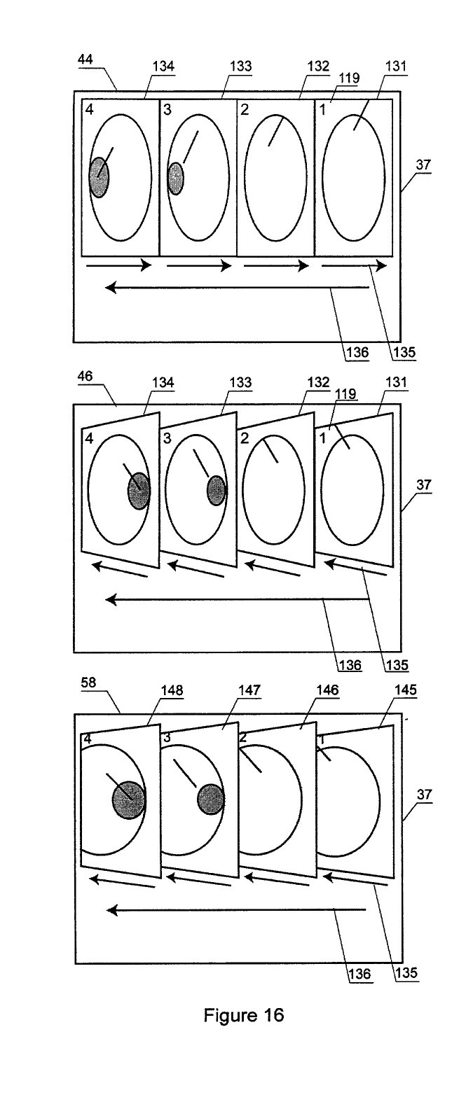

In the display formats 57 and 58 illustrated in FIG. 15 and FIG. 16, only a narrow part of image is shown without displaying all areas of image. Display format 44 in FIG. 15 corresponds to display format 44 in FIG. 8 in which each x-direction display control box 135 is set to the right, and the z-direction display control box 136 is set to the left. Display format 45 in FIG. 15 corresponds to display format 45 in FIG. 8 in which each x-direction display control box 135 is set to the upper right direction to deform image display area and to give depth perception, and the z-direction display control box 136 is set to the left. In display format 57 in FIG. 15, the width of images of slice-1, slice-2, slice-3, and slice-4 is enlarged compared to display format 45 in FIG. 15, and displayed image area 145, 146, 147, and 148 have larger width than image display areas 131, 132, 133, and 134 in display format 45 of FIG. 15. The center of magnification and the magnification ratio can be set with the x-direction display control box 135. It is sufficient to only deform the shape of frame of the image display area and to change aspect ratio of the image in display format 57, and it is not necessary to deform image itself.

Display format 44 in FIG. 16 corresponds to display format 44 in FIG. 8 in which each x-direction display control box 135 is set to the right, and the z-direction display control box 136 is set to the left. Display format 46 in FIG. 16 corresponds to display format 46 in FIG. 8 in which each x-direction display control box 135 is set to the upper left direction to deform image display area to give depth perception, and the z-direction display control box 136 is set to the left. In display format 58 in FIG. 16, the width of images of slice-1, slice-2, slice-3, and slice-4 is enlarged compared to 46 in FIG. 16, and displayed image area 145, 146, 147, and 148 have larger width than image display areas l3l, 132, 133, and 134 in display format 46 of FIG. 16. Center of magnification and magnification ratio can be set with the x-direction display control box 135. It is sufficient to only deform the shape of frame of the image display area and to change aspect ratio of the image in display format 58, and it is not necessary to deform image itself.

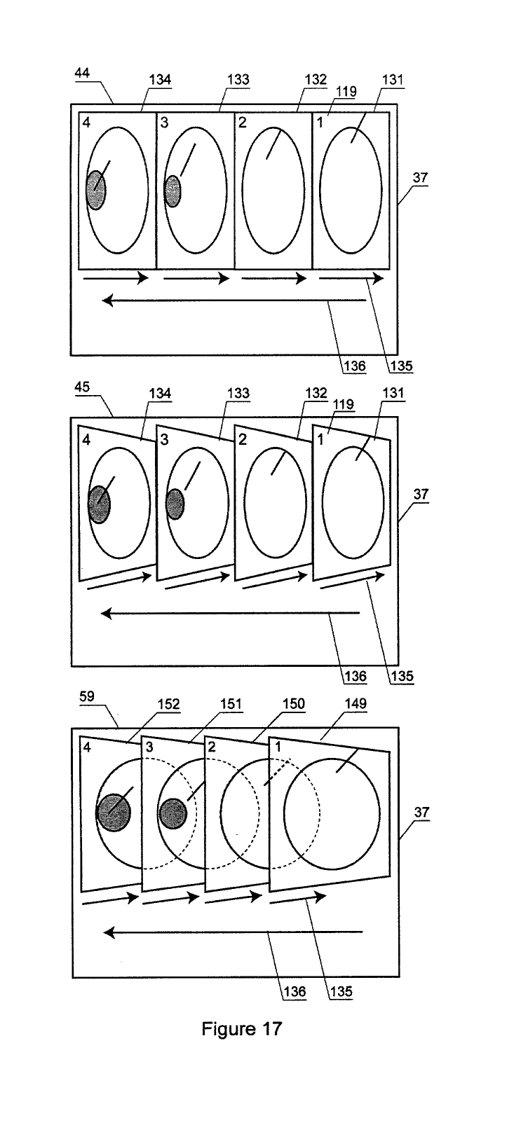

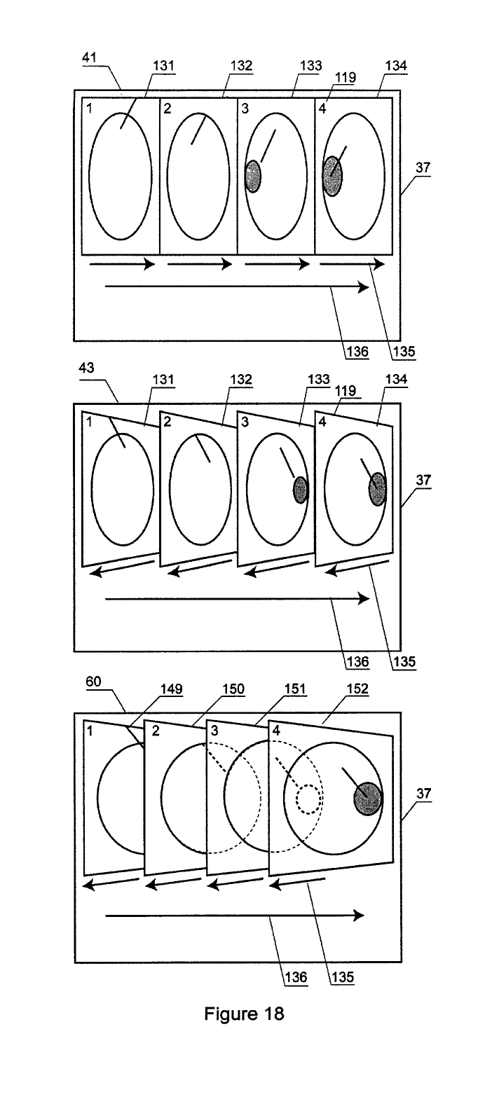

FIG. 17 and FIG. 18 illustrate display formats 59 and 60, respectively, in which images are arranged in an overlapping fashion. Each image is assigned an opacity and if the opacity of an image is less than a threshold value, images it overlaps are shown. Display format 44 in FIG. 17 is identical to display format 44 in FIG. 8 in which each x-direction display control box 135 is set to the right, and the z-direction display control box 136 is set to the left. Display format 45 in FIG. 17 corresponds to display format 45 in FIG. 8 in which each x-direction display control box 135 is set to the upper right direction to deform image display area and to give depth perception, and the z-direction display control box 136 is set to the left. In display format 59 of FIG. 17, the image width of slice-1, slice-2, slice-3, and slice-4 and image display area 149, 150, 151, and 152 have larger width than the image width of slice-1, slice-2, slice-3, and slice-4 and image display area 131, 132, 133, and 134 in display format 45 of FIG. 8. It is sufficient to only deform the shape of frame of the image display area and to change aspect ratio of the image in display format 59, and it is not necessary to deform image itself. Additionally, the images of slice-1, slice-2, and slice-3 and image display area 149, 150, and 151 have an opacity less than the threshold so that images and image display areas behind them can be seen (shown in phantom in FIG. 17).

Display format 41 in FIG. 18 corresponds to display format 41 in FIG. 7 in which each x-direction display control box 135 is set to the right, and the z-direction display control box 136 is set to the right. Display format 43 in FIG. 18 corresponds to display format 43 in FIG. 7 in which each x-direction display control box 135 is set to the lower left direction to deform image display area to give depth perception, and the z-direction display control box 136 is set to the right. Display format 60 in FIG. 18 is an example in which the image width of slice-1, slice-2, slice-3, and slice-4 and image display area 149, 150, 151, and 152 have larger width than the image width of slice-1, slice-2, slice-3, and slice-4 and image display area 131, 132, 133, and 134 in display format 43 of FIG. 18. It is sufficient to only deform the shape of frame of the image display area and to change the aspect ratio of the image in display format 60, and it is not necessary to deform image itself. Images of slice-2, slice-3, and slice-4 and image display areas 150, 151, and 152 have opacity less than the threshold so that images and image display areas behind them can be seen (shown in phantom in FIG. 18).

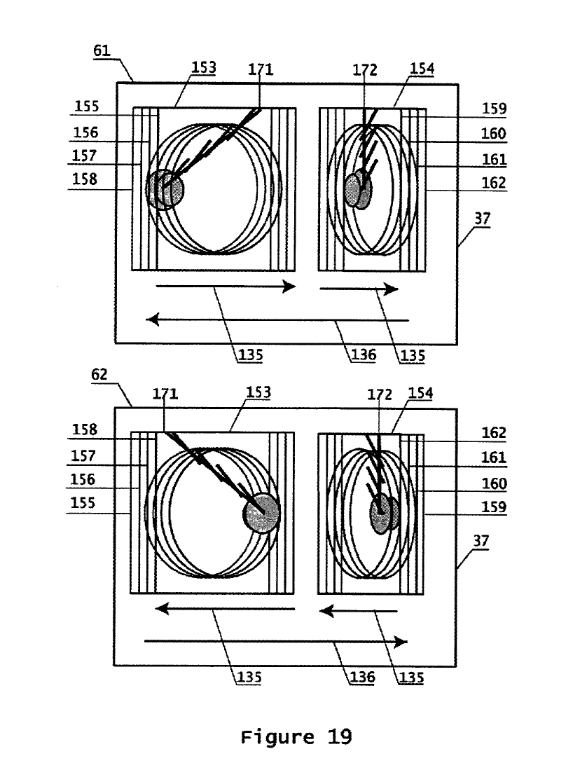

FIG. 19 illustrates display formats 61 and 62 showing the overlapping of image display areas for transparent images. An image group 153 is a group of images of slices projected on the plane defined by the biopsy needle 107 and y-axis as illustrated in FIG. 2. Image 155 is the projected image of slice 102, image 156 is the projected image of slice 103, image 157 is the projected image of slice 104, and image 158 is the projected image of slice 105. An image group 154 a group of images of slices projected on the plane that intersects perpendicularly with the plane defined by the biopsy needle 107 and y-axis and includes y-axis in FIG. 2. Image 159 is the projected image of slice 102, image 160 is the projected image of slice 103, image 161 is the projected image of slice 104, and image 162 is the projected image of slice 105. By projecting images on two planes that intersect perpendicularly, the motion of a biopsy needle may be observed more accurately. On the image, a guideline 171, 172 is displayed between the insertion point of a biopsy needle on the surface of a subject and the region of interest, and operation of the biopsy needle is made easy. The x-direction display control box 135, and z-direction display control box 136, and the display direction of images can be set up initially as shown in display format 61. As shown in display format 62, changing the x-direction display control box 135 and the z-direction display control box 136 changes the display direction.

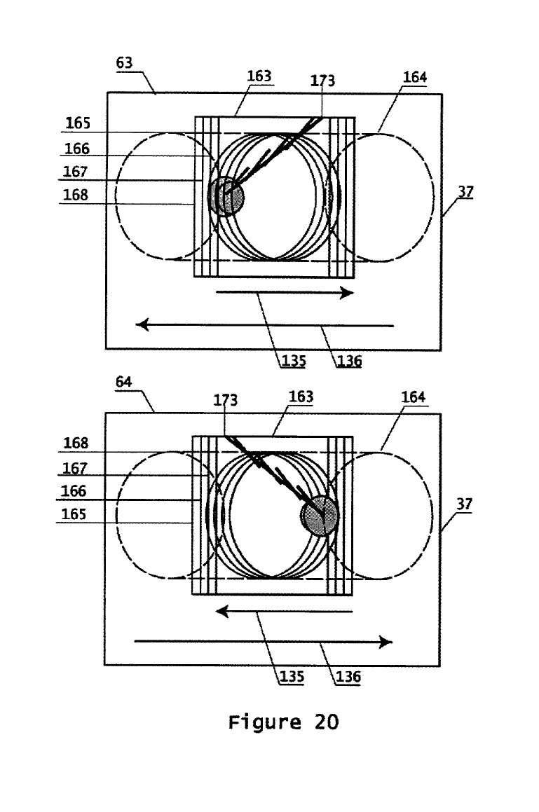

FIG. 20 illustrates display formats 63 and 64 in which image display areas are overlapped and displayed on a three-dimensional image with a different opacity. In display format 63 and display format 64, an image group 163 is group of images of slices projected on the plane defined by the biopsy needle 107 and y-axis as illustrated in FIG. 2. Image 165 is the projected image of slice 102, image 166 is the projected image of slice 103, image 167 is the projected image of slice 104, and image 168 is the projected image of slice 105. A three-dimensional image 164 is a three-dimensional image created by the CT scan preceding the insertion of biopsy needle and displayed with the same coordinate system as image group l63. In this example, image 165 of slice-1, image 166 of slice-2, image 167 of slice-3, and image 168 of slice-4 are overlapped and displayed on the three-dimensional image 164 that has same coordinate system with slices. By adjusting the display opacity of the three-dimensional image 164, the display formats 63 and 64 can show the three-dimensional image and the images of slice-1, slice-2, slice-3, and slice-4 as different opacities, making them easy to distinguish. In display format 63, subtraction images of slice-1, slice-2, slice-3, and slice-4 can be displayed as image 165 of slice-1, image 166 of slice-2, image 167 of slice-3, and image 168 of slice-4 so that only biopsy needle can be displayed on the three-dimensional image 164. Since a biopsy needle has a specific CT value, the invention extracts only the portion of a biopsy needle in each image and displays it on the three-dimensional image 164 so that only the biopsy needle is seen. By displaying on the image a guideline 173 that connects the point of insertion of the needle on the surface of a subject and the region of interest, operation of a biopsy needle can be made easy. Display format 64 in FIG. 20 illustrate the change in display direction caused by changing the x-direction display control box 135 and the z-direction display control box 136.

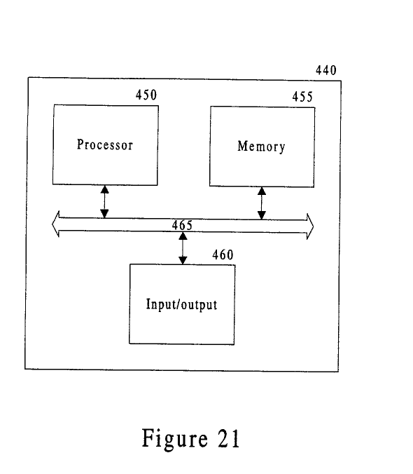

Turning now to FIG. 21, one embodiment of a computer system 400 for use with the present invention is described. The system 400, includes a processor 450, memory 455 and input/output capability 460 coupled to a system bus 465. The memory 455 is configured to store instructions which, when executed by the processor 450, perform the functions of the invention described herein. The memory 455 may also store the various tables previously described and the results of the processing of the data within those tables. Input/output 460 provides for the delivery and display of the images or portions or representations thereof. Input/output 460 also provides for access to the image data provided by other components and for user control of the operation of the invention. Further, input/output 460 encompasses various types of computer-readable media, including any type of storage device that is accessible by the processor 450. One of skill in the art will immediately recognize that the term “computer-readable medium/media” further encompasses a carrier wave that encodes a data signal.

The instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

The foregoing description of FIG. 4 is intended to provide an overview of computer hardware and other operating components suitable for implementing the invention, but is not intended to limit the applicable environments. It will be appreciated that the computer system 440 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

What is claimed is:

1. An image display apparatus for displaying multi-slice images corresponding to cross-sections of a subject in multiple display areas on a single display screen, the apparatus comprising:
means for deforming a display format of each display area; and
means for changing the display format of one of the display areas to change a relationship between the image in the one display area with an image in a display area adjacent to the one display area.

2. The image display apparatus of claim 1 further comprising means for overlapping adjacent display areas on the single display screen.

3. The image display apparatus of claim 2 further comprising means for assigning a different opacity to each display area.

4. The image display apparatus of claim 1 further comprising:
means for assigning a different opacity to each display area; and
means for arranging each display area with a different opacity on a three-dimensional image reconstructed with previously acquired data.

5. A method for displaying multi-slice images corresponding to cross-sections of a subject in multiple display areas on a single display screen, the apparatus comprising:
deforming a display format of each display area; and
changing the display format of one of the display areas to change a relationship between the image in the one display area with an image in a display area adjacent to the one display area.

6. The method of claim 5 further comprising overlapping adjacent display areas on the single display screen.

7. The method of claim 6 further comprising assigning a different opacity to each display area.

8. The method of claim 5 further comprising:
assigning a different opacity to each display area; and
arranging each display area with a different opacity on a three-dimensional image reconstructed with previously acquired data.

9. A computer-readable medium having executable instructions for performing a method comprising:
deforming a display format of each of a plurality of display areas for displaying on a single screen, each display area displaying a multi-slice image corresponding to a cross-section of a subject; and
changing the display format of one of the display areas to change a relationship between the image in the one display area with an image in a display area adjacent to the one display area.

10. The computer-readable medium of claim 9 having further executable instructions comprising overlapping adjacent display areas on the single display screen.

11. The computer-readable medium of claim 10 having further executable instructions comprising assigning a different opacity to each display area.

12. The computer-readable medium of claim 9 having further executable instructions comprising:
assigning a different opacity to each display area; and
arranging each display area with a different opacity on a three-dimensional image reconstructed with previously acquired data.

13. A computer system comprising:
a processor;
a memory coupled to the processor through a bus; and
a display process executed from the memory to cause the processor to deform a display format of each of a plurality of display areas and to change the display format of one of the display areas each display area, wherein the plurality of display areas are operable for displaying on a single display screen with each display area displaying a multi-slice image corresponding to a cross-section of a subject.

14. The computer system of claim 13, wherein the display process further causes the processor to overlap adjacent display areas for displaying on the single display screen.

15. The computer system of claim 14, wherein the display process further causes the processor to assign a different opacity to each display area.

16. The computer system of claim 13, wherein the display process further causes the processor to assign a different opacity to each display area and to arrange each display area with a different opacity on a three-dimensional image reconstructed with previously acquired data.
